(19) United States
(12) Patent Application Publication
(10) Pub. No.: US 2016/0070382 A1
(43) Pub. Date: Mar. 10, 2016

(54) DISPLAY DEVICE WITH CAPACITIVE TOUCH PANEL

(71) Applicant: ZEON CORPORATION, Tokyo (JP)

(72) Inventors: Tetsuya TOYOSHIMA, Tokyo (JP); Shunsuke YAMANAKA, Tokyo (JP)

(73) Assignee: ZEON CORPORATION, Tokyo (JP)

(21) Appl. No.: 14/782,674

(22) PCT Filed: Apr. 4, 2014
(86) PCT No.: PCT/JP2014/001958

§ 371 Date: Oct. 6, 2015

(30) Foreign Application Priority Data
Apr. 10, 2013 (JP) 2013-081971

(51) Int. Cl. G06F 3/044; G02F 1/1335; G02F 1/1333; G06F 3/041; G09G 3/36

(52) U.S. Cl. CPC G06F 3/044; G06F 3/0412; G09G 3/36; G02F 1/13338; G02F 1/133528; G06F 2203/04111; G06F 2203/04103

(57) ABSTRACT

This disclosure provides a display device with a capacitive touch panel (100) including a laminate between a display panel (20) and a cover layer (80), the laminate having a viewing-side polarizing plate (60), a first conductive layer (50), a second conductive layer (30), and a substrate (40). The viewing-side polarization plate (60) has a polarizing film (62). The first conductive layer (50), second conductive layer (30), and substrate (40) are positioned closer to the display panel (20) than is the polarizing film (62) of the viewing-side polarization plate (60). The first conductive layer (50) is positioned closer to the cover layer (80) than is the second conductive layer (30). The first conductive layer (50) and second conductive layer (30) are arranged apart from each other. One of the first conductive layer (50) and the second conductive layer (30) is formed on one surface of the substrate (40).

### TECHNICAL FIELD

This disclosure relates to a display device with a touch panel, in particular to a display device with a capacitive touch panel.

### BACKGROUND

As displays combined with input means, display devices with touch panels are widely used in electronics, such as laptop computers, OA equipment, medical equipment, car navigation devices, portable electronic devices such as mobile phones, and personal digital assistants (PDAs).

Here, different types of touch panels are known, including capacitive type, optical type, ultrasonic type, electromagnetic induction type, resistance film type, and the like. Among these, in particular, capacitive type, which detects input coordinates by monitoring changes in the electrostatic capacity between a finger tip and a conductive layer, is becoming the mainstream of current touch panels, on par with resistance film type.

As a conventional display device with a capacitive touch panel, for example, a device is known to have: a backlight-side polarizing plate; a liquid crystal panel formed with a liquid crystal layer sandwiched between two glass base plates (a thin film transistor base plate and a color filter base plate); a phase difference film for viewing angle compensation; a viewing-side polarizing plate; a touch sensor unit; and a cover glass layer, which are stacked in the stated order from the backlight side towards the viewing side. Additionally, a conventional display device with a capacitive touch panel has a touch sensor unit that is formed with, for example, two transparent base plates, each having a conductive layer formed on a surface thereof, stacked together such that the conductive layer of one transparent base plate faces a surface of the other transparent base plate on the side opposite where the conductive layer of the other transparent base plate is formed (for example, JP2013-41566A (PTL 1)).

In addition, a conventional display device with a touch panel proposes providing a quarter wavelength plate between a viewing-side polarizing plate and a cover glass layer such that linearly polarized light traveling from the liquid crystal panel side through the viewing-side polarizing plate towards the cover glass layer side is converted by the quarter wavelength plate into circularly polarized light or elliptically polarized light (see, for example, JP2009-169837A (PTL 2)). In this way, when a display device with a touch panel is operated by an individual wearing polarized sunglasses, the displayed content can be visually recognized even under the condition of so-called crossed nicols, in which a transmission axis of the viewing-side polarizing plate and the transmission axis of the polarizing sunglasses are set orthogonal to each other.

### CITATION LIST

### Patent Literature

PTL 1: JP2013-41566A

PTL 2: JP2009-169837A

### SUMMARY

### Technical Problem

Recently, there is increasing demand for further reduction in the thickness and weight of display devices with capacitive touch panels.

However, the above conventional display devices with capacitive touch panels have the problem that since a touch sensor unit is formed with two transparent base plates, each having a conductive layer formed on a surface thereof, the thickness between the liquid crystal panel and the cover glass layer increases, which results in an increase in the thickness of the entire device.

In addition, the problem of increased thickness between the liquid crystal panel and the cover glass layer becomes more pronounced, particularly in the case of many members being present between the liquid crystal panel and the cover glass layer, such as where a quarter wavelength plate is provided between the viewing-side polarizing plate and the cover glass layer in order to enable the operator to operate the display device with a tough panel through polarized sunglasses.

Therefore, a first object of the disclosure is to provide a display device with a capacitive touch panel that is reduced in thickness.

In addition, a second object of the disclosure is to provide a display device with a capacitive touch panel that can be operated by the operator even through polarized sunglasses and is reduced in thickness.

### Solution to Problem

To solve the aforementioned problem advantageously, it could thus be helpful to provide a display device with a capacitive touch panel comprising a laminate between a display panel and a cover layer, the laminate having a viewing-side polarizing plate, a first conductive layer, a second conductive layer, and a substrate, wherein the viewing-side polarizing plate has a polarizing film, and the first conductive layer, the second conductive layer, and the substrate are positioned closer to the display panel than is the polarizing film of the viewing-side polarizing plate, and the first conductive layer is positioned closer to the cover layer than is the second conductive layer, the first conductive layer and the second conductive layer are arranged apart from each other in a stacking direction so as to form a capacitive touch sensor, and one of the first conductive layer and the second conductive layer is formed on one surface of the substrate. In this way, when one of the first conductive layer and the second conductive layer is formed on the substrate, a transparent base plate is no longer needed for forming the conductive layer, and it is thus possible to simplify the structure of the touch sensor, thereby reducing the thickness between the display panel and the cover layer.

Here, it is preferred that the display device with a capacitive touch panel disclosed herein further comprises an optical film with a phase difference of (2n−1)λ/4, where n is a positive integer, between the cover layer and the viewing-side polarizing plate, wherein a slow axis of the optical film intersects a transmission axis of the polarizing film of the viewing-side polarizing plate at an angle of about 45° as viewed in the stacking direction. In this way, by providing the optical film for imparting a predetermined phase difference to light closer to the cover layer than is the viewing-side polarizing plate, and by setting the angle at which the slow axis of the optical film and the transmission axis of the polarizing film of the viewing-side polarizing plate intersect to about 45°, the display device can be operated by the operator even through polarized sunglasses.

As used herein, “about 45°” covers angles of, for example, 45±100°, at which linearly polarized light traveling from the display panel side through the viewing-side polarizing plate towards the cover layer side can be converted by the optical film into circularly polarized light or elliptically polarized light to enable operation through polarized sunglasses.

In addition, in the display device with a capacitive touch panel disclosed herein, it is preferred that the viewing-side polarizing plate has a display panel-side protective film on the side of the display panel of the polarizing film, the first conductive layer is formed on a surface, on the side of the display panel, of the display panel-side protective film of the viewing-side polarizing plate, and the second conductive layer is formed on one surface of the substrate. When the first conductive layer is formed on the surface of the display panel-side protective film of the viewing-side polarizing plate, it is possible to simplify the structure of the touch sensor even more to further reduce the thickness between the display panel and the cover layer.

In this case, it is noted that the second conductive layer may be formed on a surface of the substrate on the side of the display panel. When the second conductive layer is formed on the surface of the substrate on the side of display panel, a capacitive touch sensor can be easily formed by use of the substrate positioned between the first conductive layer and the second conductive layer.

In this case, it is also noted that the second conductive layer may be formed on a surface of the substrate on the side of the cover layer.

In the display device with a capacitive touch panel disclosed herein, it is also preferred that the display panel has a cover layer-side cell base plate at a surface thereof on the side of the cover layer, the second conductive layer is formed on a surface, on the side of the cover layer, of the cover layer-side cell base plate of the display panel, and the first conductive layer is formed on one surface of the substrate. When the second conductive layer is formed on the surface of the cover layer-side cell base plate of the display panel, it is possible to simplify the structure of the touch sensor even more to further reduce the thickness between the display panel and the cover layer.

In this case, it is noted that the first conductive layer may be formed on the surface of the substrate on the side of the cover layer. When the first conductive layer is formed on the surface of the substrate on the side of the cover layer, a capacitive touch sensor can be easily formed by use of the substrate positioned between the first conductive layer and the second conductive layer.

Also, in this case, the first conductive layer may be formed on the surface of the substrate on the side of the display panel, and furthermore, it is preferred that the polarizing film is positioned on a surface of the viewing-side polarizing plate on the side of the display panel, and that the substrate is bonded to a surface of the polarizing film on the side of the display panel. In this way, the substrate can be used as a protective film for the polarizing film, which makes it possible to eliminate the need for the protective film of the polarizing film and to further reduce the thickness between the display panel and the cover layer.

Additionally, in the display device with a capacitive touch panel disclosed herein, it is preferred that the optical film is an obliquely stretched film. When the optical film is an obliquely stretched film, a laminate including the viewing-side polarizing plate and the optical film can be produced easily by a roll-to-roll process.

In addition, in the display device with a capacitive touch panel disclosed herein, it is preferred that a cycloolefin polymer, polycarbonate, polyethylene terephthalate, or triacetyl cellulose is used in at least one of the substrate and the optical film and, particularly preferably, a cycloolefin polymer without a polar group is used in at least one of the substrate and the optical film. Moreover, the substrate preferably has a relative permittivity of 2 or more and 5 or less. In addition, the substrate preferably has a saturated water absorption of 0.01 mass % or less. Moreover, where the viewing-side polarizing plate has a display panel-side protective film on the side of the display panel of the polarizing film, the first conductive layer is formed on a surface, on the side of the display panel, of the display panel-side protective film of the viewing-side polarizing plate, and the second conductive layer is formed on a surface of the substrate on the side of the display panel, or alternatively where the display panel has a cover layer-side cell base plate at a surface thereof on the side of the cover layer, the second conductive layer is formed on a surface, on the side of the cover layer, of the cover layer-side cell base plate of the display panel, and the first conductive layer is formed on a surface of the substrate on the side of the cover layer, it is particularly preferred that the substrate has a relative permittivity of 2 or more and 5 or less, and/or the substrate has a saturated water absorption of 0.01 mass % or less, and/or a cycloolefin polymer without a polar group is used in at least one of the substrate and the optical film. By using the aforementioned substrate and/or the optical film, a capacitive touch sensor can be formed favorably.

As used herein, the “relative permittivity” may be measured in accordance with ASTM D150. Also, as used herein, the “saturated water absorption” may be measured following ASTM D570.

Furthermore, in the display device with a capacitive touch panel disclosed herein, it is preferred that the substrate has a film, and further has at least one of a first index matching layer positioned between the film and the first conductive layer, and a second index matching layer positioned between the film and the second conductive layer. Arranging an index matching layer may improve visibility.

Additionally, in the display device with a capacitive touch panel disclosed herein, it is preferred that at least one of the first conductive layer and the second conductive layer is formed by using indium tin oxide, carbon nanotubes, or silver nanowires.

It is also preferred that the cover layer is made of glass or plastic.

Moreover, it is preferred that the display panel is a liquid crystal panel formed with a liquid crystal layer sandwiched between two cell base plates.

### Advantageous Effect

According to the disclosure, it is possible to provide a display device with a capacitive touch panel that is reduced in thickness.

In addition, according to a preferred embodiment of the disclosure, it is possible to provide a display device with a capacitive touch panel that can be operated even through polarized sunglasses and is reduced in thickness.

### BRIEF DESCRIPTION OF DRAWINGS

In the accompanying drawings:

FIG. 1 is a diagram schematically illustrating a cross-sectional structure of the main part of a display device with a capacitive touch panel according to the disclosure;

FIG. 2 is a diagram schematically illustrating a cross-sectional structure of the main part of a variation of the display device with a capacitive touch panel illustrated in FIG. 1;

FIG. 3 is a diagram schematically illustrating a cross-sectional structure of the main part of another display device with a capacitive touch panel according to the disclosure; and

FIG. 4 is a diagram schematically illustrating a cross-sectional structure of the main part of a variation of the display device with a capacitive touch panel illustrated in FIG. 3.

### DETAILED DESCRIPTION

Embodiments of the disclosed display device with a capacitive touch panel will be described in detail with reference to the drawings. It is noted that the same reference numerals indicate the same components throughout the drawings. It is also noted that an additional layer or film may also be provided in any space between the members illustrated in the drawings within a range in which the object of the disclosure can be achieved. Here, examples of such additional layers or films include adhesive layers or pressure sensitive adhesive layers that are used to bond members together into a single structure. Preferred adhesive layers or pressure sensitive adhesive layers are transparent to visible light and do not cause any unnecessary phase difference.

### Display Device with Capacitive Touch Panel

### First Embodiment

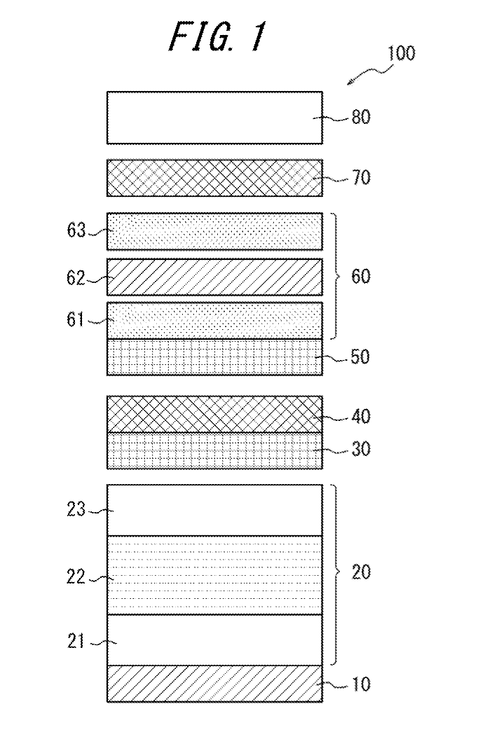

FIG. 1 illustrates the structure of the main part of an example of the display device with a capacitive touch panel according to the disclosure. It is noted here that the display device with a capacitive touch panel 100 illustrated in FIG. 1 is a device that has both a display function and a touch sensor function, the display function for displaying image information on the screen and the touch sensor function for detecting a position on the screen touched by the operator and outputting it as an information signal to the outside.

The display device with a capacitive touch panel 100 comprises the following members stacked in the stated order from the side from which the backlight is emitted (the lower side of FIG. 1, and this side is hereinafter referred to simply as the “backlight side”) towards the side from which the operator views an image (the upper side of FIG. 1, and this side is hereinafter referred to simply as the “viewing side”): a backlight-side polarizing plate 10; a liquid crystal panel 20 as a display panel; a second conductive layer 30; a substrate 40; a first conductive layer 50; a viewing-side polarizing plate 60; an optical film 70; and a cover layer 80. Additionally, in the display device with a capacitive touch panel 100, the viewing-side polarizing plate 60 has a polarizing film 62, a liquid crystal panel-side protective film (display panel-side protective film) 61 disposed on the liquid crystal panel 20 side of the polarizing film 62, and a cover layer-side protective film 63 disposed on the cover layer 80 side of the polarizing film 62, and the first conductive layer 50 is formed on a surface, on the liquid crystal panel 20 side, of the liquid crystal panel-side protective film 61 of the viewing-side polarizing plate 60, and the second conductive layer 30 is formed on one surface of the substrate 40 (that is located on the liquid crystal panel 20 side).

It is noted that the backlight-side polarizing plate 10, the liquid crystal panel 20, the substrate 40 with the second conductive layer 30 formed on the surface thereof, the viewing-side polarizing plate 60 with the first conductive layer 50 formed on the surface of the liquid crystal panel-side protective film 61, the optical film 70, and the cover layer 80 may be integrated into a single structure by bonding the members together using known means, such as providing adhesive layers or pressure sensitive adhesive layers, performing plasma treatment on the surfaces of members, and the like.

[Backlight-Side Polarizing Plate]

As the backlight-side polarizing plate 10, a known polarizing plate having a polarizing film, for example, a polarizing plate formed with a polarizing film sandwiched between two protective films may be used. Additionally, the backlight-side polarizing plate 10 is arranged so that a transmission axis of the polarizing film of the backlight-side polarizing plate 10 and a transmission axis of a polarizing film 62 of a viewing-side polarizing plate 60 as detailed below are set orthogonal to each other as viewed in the stacking direction (the vertical direction in FIG. 1), and enables images to be displayed by use of the liquid crystal panel 20.

[Liquid Crystal Panel]

As the liquid crystal panel 20, for example, a liquid crystal panel may be used that is formed with a liquid crystal layer 22 sandwiched between a thin film transistor base plate 21 positioned on the backlight side and a color filter base plate (cover layer-side cell base plate) 23 positioned on the viewing side. Additionally, in the display device with a capacitive touch panel 100, the liquid crystal layer 22 of the liquid crystal panel 20, which is arranged between the backlight-side polarizing plate 10 and the viewing-side polarizing plate 60, is energized to present a desired image to the operator.

It is noted that as the thin film transistor base plate 21 and the color filter base plate 23, known base plates may be used. In addition, as the liquid crystal layer 22, a known liquid crystal layer may be used. It is noted that the display panel which may be used in the display device with a capacitive touch panel disclosed herein is not limited to the liquid crystal panel 20 with the aforementioned structure.

[Second Conductive Layer]

The second conductive layer 30 is formed on one surface of the substrate 40, and is positioned between the liquid crystal panel 20 and the substrate 40, more specifically, between the color filter base plate 23 of the liquid crystal panel 20 and the substrate 40. Additionally, the second conductive layer 30 forms a capacitive touch sensor, in conjunction with the first conductive layer 50 positioned apart in the stacking direction across the substrate 40.

Here, the second conductive layer 30 may be any layer as long as it has transmittance in the visible light region and has conductivity, and may be formed by using any suitable material including, but not particularly limited to, conductive polymers; conductive pastes such as silver paste and polymer paste; metal colloids such as gold and copper; metal oxides such as indium tin oxide (tin-doped indium oxide: ITO), antimony-doped tin oxide (ATO), fluorine-doped tin oxide (FTO), aluminum-doped zinc oxide (AZO), cadmium oxide, cadmium-tin oxide, titanium oxide, and zinc oxide; metal compounds such as copper iodide; metals such as gold (Au), silver (Ag), platinum (Pt), and palladium (Pd); and inorganic or organic nanomaterials such as silver nanowires and carbon nanotubes (CNTs). Among these, indium tin oxide, carbon nanotubes, and silver nanowires are preferred, and particularly preferred is indium tin oxide from a light transmittivity and durability perspective.

It is noted that when CNTs are used, any of single-walled CNTs, double-walled CNTs, triple- or higher order multi-walled CNTs may be used, yet the diameter of the CNTs used is preferably from 0.3 nm to 100 nm and the length thereof is preferably from 0.1 μm to 20 μm. It is noted that from the viewpoint of increasing transparency of conductive layers and reducing the surface resistance, single-walled CNTs or double-walled CNTs of 10 nm or less in diameter and 1 μm to 10 μm in length are preferably used. It is also preferred that the collection of CNTs contain as few impurities as possible, such as amorphous carbon and catalyst metal.

Additionally, the formation of the second conductive layer 30 on the surface of the substrate 40 is not particularly limited, and may be performed by a sputtering method, a vacuum evaporation method, a CVD method, an ion plating method, a sol-gel method, a coating method, or the like.

[Substrate]

The substrate 40 is not particularly limited, and various films such as a phase difference film and the like or substrates formed by disposing various layers on the film may be used. However, a phase difference film, or a substrate formed by disposing a hard coat layer, or an optical functional layer such as an index-matching layer, low refractive index layer, and the like, on the phase difference film, is preferably used. Here, the phase difference film is an optical compensation film which compensates for viewing angle dependence of the liquid crystal layer 22, a light leakage phenomenon occurring at the polarizing plates 10, 60 at the time of oblique angle viewing, and the like to thereby improve viewing angle characteristics of the display device with a capacitive touch panel 100.

Additionally, the substrate 40 is positioned between the second conductive layer 30 and the first conductive layer 50, and functions as an insulating layer for the capacitive touch sensor which is formed by the first conductive layer 50 and the second conductive layer 30.

As the film used in the substrate 40, for example, a known vertical uniaxial stretched film, a known horizontal uniaxial stretched film, a known vertical and horizontal biaxial stretched film, or a phase difference film obtained by polymerizing a liquid crystalline compound may be used. Specifically, the film used in the substrate 40 is not particularly limited, and examples thereof include a film that is obtained by uniaxially or biaxially stretching a thermoplastic resin film produced by forming a thermoplastic resin into a film by a known method.

It is noted that when the substrate 40 has a phase difference film (including the case where the substrate 40 itself is a phase difference film), the phase difference film may be arranged so that the slow axis of the phase difference film and the transmission axis of the polarizing film of each of the polarizing plates 10, 60 are, for example, parallel or orthogonal to each other as viewed in the stacking direction.

Examples of the thermoplastic resins which can be used to form the substrate 40 include, but are not particularly limited to, cycloolefin polymers, polycarbonate, polyarylate, polyethylene terephthalate, triacetyl cellulose, polysulfone, polyethersulfone, polyphenylene sulfide, polyimide, polyamide imide, polyvinyl chloride, polystyrene, polyolefin (such as polyethylene and polypropylene), polyvinyl alcohol, and polyvinyl chloride-polymethyl methacrylate. Among these, preferred are cycloolefin polymers, polycarbonate, polyethylene terephthalate, and triacetyl cellulose, more preferred are cycloolefin polymers because of their low relative permittivity, and particularly preferred are cycloolefin polymers without a polar group such as an amino group, a carboxyl group, and a hydroxyl group because of their low relative permittivity and low water absorption.

Examples of cycloolefin polymers may include norbornene-based resins, monocyclic olefin-based resins, cyclic conjugated diene-based resins, vinyl alicyclic hydrocarbon-based resins, and hydrides thereof. Among these, norbornene-based resins are suitably used because of their good transparency and good formability.

Examples of norbornene-based resins may include: a ring-opened polymer of a monomer with norbornene structure, a ring-opened copolymer of a monomer with norbornene structure and another monomer, and hydrides thereof, and an addition polymer of a monomer with norbornene structure, an addition copolymer of a monomer with norbornene structure and another monomer, and hydrides thereof.

Examples of commercially available cycloolefin polymers include “Topas” (manufactured by Ticona GmbH), “ARTON” (manufactured by JSR Corporation), “ZEONOR” and “ZEONEX” (manufactured by Zeon Corporation), “APEL” (manufactured by Mitsui Chemicals, Inc.), all of which are trade names. By forming such a cycloolefin-based resin into a film, the film made from a thermoplastic resin can be obtained. For film formation, a known film formation method is appropriately used, such as a solvent casting method and a melt extrusion method. Cycloolefin-based resin films obtained by a film formation method are also commercially available, and examples thereof include “Essina” and “SCA40” (manufactured by Sekisui Chemical Co., Ltd.), “ZEONOR Film” (manufactured by Zeon Corporation), and “ARTON FILM” (manufactured by JSR Corporation), all of which are trade names. A thermoplastic resin film before stretching is generally a long unstretched film. In this context, a “long” film indicates a film having a length of at least about 5 times or more, preferably 10 times or more, the width of the film, and specifically a film having a length long enough for the film to be wound into a roll for storage or transportation.

The aforementioned thermoplastic resin has a glass-transition temperature of preferably 80° C. or higher, and more preferably from 100° C. to 250° C. In addition, when the thermoplastic resin film is used as the phase difference film, the photoelastic coefficient of the thermoplastic resin is, in absolute value, preferably 10×10⁻¹² Pa⁻¹ or less, more preferably 7×10⁻¹² Pa⁻¹ or less, and particularly preferably 4×10⁻¹² Pa⁻¹ or less. Photoelastic coefficient σ is a value represented by C=Δn/σ, where Δn is birefringence and σ is stress. By using a transparent thermoplastic resin whose photoelastic coefficient falls within this range, it is possible to reduce variations in in-plane direction retardation Re of the phase difference film. Moreover, when such a phase difference film (optical compensation film) is applied to a display device using a liquid crystal panel, it is possible to suppress a phenomenon that alters the hue at edges of the display screen of the display device.

It is noted that the thermoplastic resin used to form the substrate 40 may be blended with other compounding agents. The compounding agents are not particularly limited, and examples thereof include layered crystal compounds; inorganic fine particles; stabilizers such as antioxidants, heat stabilizers, light stabilizers, weathering stabilizers, ultraviolet absorbers, and near-infrared absorbers; resin modifiers such as lubricants and plasticizers; coloring agents such as dyes and pigments; and antistatic agents. These compounding agents may be used alone or in combination of two or more, and the blending amount thereof is properly selected within a range not to impair the object of the disclosure.

Examples of antioxidants include phenolic antioxidants, phosphoric antioxidants, and sulfuric antioxidants, and among these preferred are phenolic antioxidants, and particularly preferred are alkyl-substituted phenolic antioxidants. By blending these antioxidants, it is possible to prevent coloring of the film and decrease in strength of the film due to oxidation deterioration during the film formation, without deteriorating transparency, low water absorption properties, and the like. These antioxidants may be used alone or in combination of two or more, and the blending amount thereof is properly selected within a range not to impair the object of the disclosure, yet is normally 0.001 parts by mass to 5 parts by mass, and preferably 0.01 parts by mass to 1 part by mass, per 100 parts by mass of the thermoplastic resin.

Inorganic fine particles that have an average particle size of 0.7 μm to 2.5 μm and a refractive index of 1.45 to 1.55 are preferred. Specific examples thereof include clay, talc, silica, zeolite, and hydrotalcite, and among these preferred are silica, zeolite, and hydrotalcite. The addition amount of inorganic fine particles is not particularly limited, yet is normally 0.001 parts by mass to 10 parts by mass, and preferably 0.005 parts by mass to 5 parts by mass, per 100 parts by mass of the thermoplastic resin.

Examples of lubricants include hydrocarbon-based lubricants; fatty acid-based lubricants; higher alcohol-based lubricants; fatty acid amide-based lubricants; fatty acid ester-based lubricants; and metallic soap-based lubricants. Among these, preferred are hydrocarbon-based lubricants, fatty acid amide-based lubricants, and fatty acid ester-based lubricants. Further, of these preferred lubricants, particularly preferred are those having a melting point of 80° C. to 150° C. and an acid value of 10 mg KOH/mg or lower.

If the melting point is out of the range of 80° C. to 150° C. and in addition the acid value is greater than 10 mg KOH/mg, the haze value can increase.

Additionally, the thickness of the substrate 40 and, if the substrate 40 has a phase difference film, the thickness of the phase difference film are, for example, suitably set in the range of approximately 5 μm to 200 μm, and are preferably from 20 μm to 100 μm. If the thickness of the substrate 40 is excessively small, strength can be insufficient, while the thickness is excessively large, transparency can be deteriorated. In addition, if the thickness of the phase difference film is excessively small, the retardation value can be insufficient, while the thickness is excessively large, it can be difficult to obtain a desired retardation value.

In addition, when the substrate 40 has a phase difference film, it is preferred that the content of volatile components remaining in the phase difference film is 100 ppm by mass or less. A phase difference film whose volatile component content is in the above range is free from display unevenness even after prolonged use, and presents great stability of optical properties. Here, the volatile components are substances that are contained in trace amounts in the thermoplastic resin, that have a molecular weight of 200 or less, and that have a relatively low boiling point, and examples thereof include residual monomers remained in the thermoplastic resin after polymerization of the thermoplastic resin, and the solvent. The content of volatile components may be determined by analyzing the thermoplastic resin with gas chromatography.

Additionally, the saturated water absorption of the substrate 40 and, if the substrate 40 has a phase difference film, the saturated water absorption of the phase difference film are preferably 0.01 mass % or less, and more preferably 0.007 mass % or less. If the saturated water absorption of the substrate 40 exceeds 0.01 mass %, the substrate 40 may be subject to dimensional changes depending on the usage environment, and internal stress may occur. Additionally, if the saturated water absorption of the phase difference film exceeds 0.01 mass %, display unevenness can occur, such as partial lightening of a black presentation (assuming a whitish appearance), for example, when using a reflection type liquid crystal panel as the liquid crystal panel 20. By contrast, a phase difference film whose saturated water absorption is in the above range is free from display unevenness even after prolonged use, and presents great stability of optical properties.

In addition, when the saturated water absorption of the substrate 40 is 0.01 mass % or less, it is possible to suppress the change in relative permittivity of the substrate 40 over time due to water absorption. Therefore, as illustrated in FIG. 1, even if the substrate 40 is arranged between the first conductive layer 50 and the second conductive layer 30 constituting the capacitive touch sensor, it is possible to reduce variations in detection sensitivity of the touch sensor due to change in the relative permittivity of the substrate 40.

It is noted that the saturated water absorption of the substrate 40 and of the phase difference film may be adjusted by changing, for example, the type of the thermoplastic resin used in the formation of the film.

Also, the relative permittivity of the substrate 40 is preferably 2 or more and preferably 5 or less, and particularly preferably 2.5 or less. The reason is as described below. As illustrated in FIG. 1, in this example of the display device with a capacitive touch panel 100, the substrate 40 is arranged between the first conductive layer 50 and the second conductive layer 30 constituting the capacitive touch sensor. Therefore, by decreasing the relative permittivity of the substrate 40, it is possible to reduce the electrostatic capacity between the first conductive layer 50 and the second conductive layer 30 to improve the detection sensitivity of the capacitive touch sensor.

[[Hard Coat Layer]]

Hard coat layers are for preventing damage to and curling of the phase difference film. As the material used in the formation of the hard coat layers, a material that shows a hardness of “HB” or higher in the pencil hardness test prescribed in JIS K5700 is suitable. Examples of such materials include: hard coat layer-forming organic materials such as organic silicone-based, melamine-based, epoxy-based, acrylate-based, and polyfunctional (meth)acrylic-based compounds; and hard coat layer-forming inorganic materials such as silicon dioxide. Among these, (meth)acrylate-based compounds and polyfunctional (meth)acrylic-based compounds are preferably used as the hard coat layer-forming material in view of their good adhesive strength and excellent productivity. As used herein, “(meth)acrylate” refers to acrylate and/or methacrylate, and “(meth)acrylic” refers to acrylic and/or methacrylic.

Examples of (meth)acrylates include those having one polymerizable unsaturated group per molecule, those having two polymerizable unsaturated groups per molecule, those having three or more polymerizable unsaturated groups per molecule, and (meth)acrylate oligomers containing three or more polymerizable unsaturated groups per molecule. The (meth)acrylates may be used alone or in combination of two or more.

The method of forming the hard coat layers is not particularly limited. The hard coat layers are formed by: coating a coating liquid including the hard coat layer-forming material on the phase difference film by a known method, such as a dipping method, a spray method, a slide coating method, a bar coating method, a roll coater method, a die coater method, a gravure coater method, and a screen printing method; removing the solvent by drying in air or in a nitrogen atmosphere or the like; and subsequently, either applying thereon a hard coat layer-forming acrylic-based material and irradiating it with ultraviolet light, electron beam, or the like so as to be cured by crosslinking, or applying thereon a hard coat layer-forming silicone-based, melamine-based, or epoxy-based material and causing it to thermoset. Since the film thickness of the coating film tends to become uneven during the drying process, it is preferred to adjust and control air intake and exhaust to avoid deterioration in the appearance of the coating film, so that the coating film becomes uniform over the entire surface. When using an ultraviolet curable material, the irradiation time it takes for the hard coat layer-forming material after the coating to be cured by being irradiated with ultraviolet light is usually in the range of 0.01 seconds to 10 seconds, and the amount of irradiation from the energy ray source is usually in the range of 40 mJ/cm² to 1000 mJ/cm² in terms of cumulative exposure with ultraviolet light wavelength of 365 nm. The ultraviolet light irradiation may be performed in an inert gas such as nitrogen and argon, or in air.

It is noted that if the hard coat layers are provided, surface treatment may be applied to the phase difference film for the purpose of increasing the adhesiveness to the hard coat layers. Examples of the surface treatment include plasma treatment, corona treatment, alkali treatment, and coating treatment. In particular, in the case where the phase difference film is formed from a thermoplastic norbornene-based resin, the use of corona treatment allows for providing strong adhesion between the phase difference film formed from the thermoplastic norbornene-based resin and the hard coat layers. As a corona treatment condition, the amount of irradiation of corona discharge electron is preferably 1 W/m²/min to 1000 W/m²/min. The contact angle with water of the phase difference film after the above corona treatment is preferably from 10° to 50°. In addition, coating with the coating liquid including the hard coat layer-forming material may be performed immediately after the corona treatment or after neutralization. For better appearance of the hard coat layers, however, the coating is preferably performed after neutralization.

The hard coat layers formed on the phase difference film normally have an average thickness of 0.5 μm or more and 30 μm or less, and preferably 2 μm or more and 15 μm or less. If the hard coat layers are increased in thickness excessively out of this range, this may cause a problem with visibility, while if the hard coat layers are reduced in thickness excessively, this may result in poor scratch resistance.

The haze of the hard coat layers is 0.5% or less, and preferably 0.3% or less. By setting such haze values, the hard coat layers can be used suitably in the display device with a touch panel 100.

In addition, to the hard coat layer-forming material may be added, without departing from the spirit of the disclosure, organic particles, inorganic particles, a photosensitizer, a polymerization inhibitor, a polymerization initiation aid, a leveling agent, a wettability improving agent, a surfactant, a plasticizer, an ultraviolet absorber, an antioxidant, an antistatic agent, a silane coupling agent, and the like.

It is noted that in the display device with a capacitive touch panel according to the disclosure, the substrate 40 may not have hard coat layers, or alternatively the substrate 40 may have an optical functional layer, such as an index matching layer and a low refractive index layer, instead of or in addition to the hard coat layers.

[[Index Matching Layer]]

Here, an index matching layer is provided (at the interface) between the film such as the phase difference film constituting the substrate 40 and the conductive layer formed on the substrate 40 (in this example, the second conductive layer 30), for the purpose of preventing reflection of light at the interface between the layers caused by the difference in refractive index between the film constituting the substrate 40 and the conductive layer. Examples of the index matching layer include those comprising multiple high refractive index films and multiple low refractive index films that are alternately arranged, and resin layers comprising metals such as zirconia. Even if the film constituting the substrate 40 and the second conductive layer 30 greatly differ in refractive index, arranging an index matching layer adjacent to the second conductive layer 30 between the film and the second conductive layer 30 makes it possible to prevent the reflectance from varying significantly at regions in the substrate 40, depending on whether the conductive layer is provided or not.

[[Low Refractive Index Layer]]

A low refractive index layer is provided for the purpose of preventing reflection of light and may be provided, for example, on each of the hard coat layers. If provided on the hard coat layers, the respective low refractive index layers represent layers, each having a refractive index lower than that of the hard coat layers. The refractive index of each low refractive index layer is preferably in the range of 1.30 to 1.45, and more preferably in the range of 1.35 to 1.40, at 23° C. and wavelength of 550 nm.

As the low refractive index layers, inorganic compounds that are formed from SiO₂, TiO₂, NaF, Na₃AlF₆, LiF, MgF₂, CaF₂, SiO, SiOₓ, LaF₃, CeF₃, Al₂O₃, CeO₂, Nd₂O₃, Sb₂O₃, Ta₂O₅, ZrO₂, ZnO, ZnS, or the like are preferred. In addition, a mixture of an inorganic compound with an organic compound such as an acrylic resin, a urethane resin, and a siloxane-based polymer is preferably used as the low refractive index layer-forming material. One example is a low refractive index layer that is formed by applying a composition containing an ultraviolet curable resin and hollow silica particles, and irradiating with ultraviolet light. The film thickness of the low refractive index layer is preferably 70 nm or more and 120 nm or less, and more preferably 80 nm or more and 110 nm or less. If the film thickness of the low refractive index layer is more than 120 nm, reflected colors are so tinged that color reproducibility is lost at the time of black presentation, which fact may reduce visibility and cause undesirable results.

[First Conductive Layer]

The first conductive layer 50 is formed on a surface of the viewing-side polarizing plate 60 on the liquid crystal panel 20 side, more specifically, on a surface, on the liquid crystal panel 20 side, of the liquid crystal panel-side protective film (display panel-side protective film) 61 of the viewing-side polarizing plate 60. The first conductive layer 50 is positioned closer to the cover layer 80 than is the second conductive layer 30, more specifically, between the substrate 40 and the liquid crystal panel-side protective film 61 of the viewing-side polarizing plate 60. Additionally, the first conductive layer 50 forms a capacitive touch sensor, in conjunction with the second conductive layer 30 positioned apart in the stacking direction across the substrate 40.

Additionally, the first conductive layer 50 may be formed by using the same material as the second conductive layer 30.

In addition, the formation of the first conductive layer 50 on the surface of the liquid crystal panel-side protective film 61 of the viewing-side polarizing plate 60 may be performed by using the same method as the second conductive layer 30.

Here, the conductive layers 30, 50 constituting the capacitive touch sensor are often formed in a patterned manner. Specifically, the first conductive layer 50 and the second conductive layer 30 constituting the capacitive touch sensor may be formed in a pattern such that they form a rectilinear lattice, a wavy lattice, or a diamond-like lattice when arranged in opposition to each other and viewed in the stacking direction. It is noted that the wavy lattice refers to a shape having at least one curved section between intersections.

It is noted that the thickness of the first conductive layer 50 and of the second conductive layer 30, when formed from ITO, may be, for example, and without limitation, preferably from 10 am to 150 nm, and more preferably from 15 nm to 70 nm. The surface resistivity of the first conductive layer 50 and of the second conductive layer 30 may be preferably, but not particularly limited to, 100 Ω/sq to 1000 Ω/sq.

[Viewing-Side Polarizing Plate]

The viewing-side polarizing plate 60 is not particularly limited, and an example thereof may be a polarizing plate 60 that is formed with the polarizing film 62 sandwiched between two protective films (liquid crystal panel-side protective film 61 and cover layer-side protective film 63).

The polarizing film 62 may be one obtained, for example, by absorbing iodine or a dichroic dye on a polyvinyl alcohol film, and then uniaxially stretching in boric acid bath, or obtained by absorbing iodine or a dichroic dye on a polyvinyl alcohol film and stretching, and further modifying a part of polyvinyl alcohol units in the molecular chain to polyvinylene units.

In addition, as the protective films 61 and 63, it is possible to use one obtained by stretching a film containing a thermoplastic resin such as diacetyl cellulose, triacetyl cellulose, alicyclic olefin polymer, acrylic resin, polycarbonate, polyethersulfone, polyethylene terephthalate, polyimide, polymethyl methacrylate, polyethylene methacrylate, polysulfone, polyethylene, polystyrene, polyvinyl chloride, and the like by using a conventional method such as horizontal uniaxial stretching, simultaneous biaxial stretching, successive biaxial stretching, oblique stretching and the like, or one obtained by forming an optical anisotropic layer on a non-stretched thermoplastic resin film, and then performing stretching. The stretched film may be either in the form of a monolayer or in the form of a laminate of stacked layers.

[Optical Film]

The optical film 70 is not particularly limited, and an optical film with a phase difference of (2n−1)λ/4, where n is a positive integer, is preferably used. It is noted that the optical film 70 is arranged so that a slow axis of the optical film 70 and a transmission axis of the polarizing film 62 of the viewing-side polarizing plate 60 intersect at a predetermined angle as viewed in the stacking direction.

As used herein, “a predetermined angle” refers to an angle at which linearly polarized light traveling from the liquid crystal panel 20 side through the viewing-side polarizing plate 60 towards the cover layer 80 side can be converted into circularly polarized light or elliptically polarized light to enable the operator to visually recognize the displayed content even through polarized sunglasses. Specifically, the predetermined angle is about 45°, which more specifically covers angles of 45°±10°, preferably 45°±3°, more preferably 45°±1°, and even more preferably 45°±0.3°.

In addition, the phrase “with a phase difference of (2n−1)λ/4, where n is a positive integer” indicates that the phase difference (retardation Re) to be applied to light transmitted through the optical film 70 in the stacking direction is about (2n−1)λ/4 times the wavelength λ of the light, where n is a positive integer, which is preferably 1. Specifically, in the case where the transmitted light has a wavelength range from 400 nm to 700 nm, and when Re is about (2n−1)λ/4 times the wavelength λ, it is meant that Re is in the range of (2n−1)λ/4±65 nm, preferably in the range of (2n−1)λ/4±30 nm, and more preferably in the range of (2n−1)λ/4±10 nm. It is noted that Re is the retardation in the in-plane direction represented by the equation Re=(nx−ny)×d, where nx is the refractive index in the film plane in the slow axis direction, ny is the refractive index in a direction orthogonal, in the film plane, to the slow axis in the film plane, and d is the thickness of the optical film 70.

As the optical film 70, it is possible to use a film subjected to orientation treatment that is obtained by forming a thermoplastic resin into a film and stretching the film.

Here, a thermoplastic resin may be stretched by any known stretching method, yet a preferred method is oblique stretching. The reason is as described below. Although the optical film 70 needs to be stacked such that the slow axis of the optical film 70 and the transmission axis of the polarizing film 62 of the viewing-side polarizing plate 60 intersect at a predetermined angle, a stretched film subjected to general stretching treatment (vertical stretching treatment or horizontal stretching treatment) has an optical axis oriented in a direction either parallel or orthogonal to the width direction of the film. Accordingly, to stack the general stretched film and the polarizing film one on top of the other at a predetermined angle, the stretched film needs to be cut at an angle into a sheet of material. An obliquely stretched film, however, has an optical axis oriented in a direction inclined at an angle with respect to the width direction of the film. Accordingly, when an obliquely stretched film is used as the optical film 70, a laminate including the viewing-side polarizing plate 60 and the optical film 70 can be produced easily by a roll-to-roll process. It is noted that in the case of producing a laminate including the viewing-side polarizing plate 60 and the laminate including the optical film 70 by a roll-to-roll process, it suffices for the orientation angle of the obliquely stretched film used as the optical film 70 to be adjusted such that the slow axis of the optical film 70 and the transmission axis of the polarizing film 62 of the viewing-side polarizing plate 60 intersect at the aforementioned predetermined angle in the resulting laminate.

Methods for use in the oblique stretching may include those described in JPS50-83482A, JPH2-113920A, JPH3-182701A, JP2000-9912A, JP2002-86554A, JP2002-22944A, and the like. The stretching machine used for oblique stretching is not particularly limited, and a possible stretching machine is a conventionally known tenter-type stretching machine. Although there are different types of tenter-type stretching machines including horizontal uniaxial stretching machines and simultaneous biaxial stretching machines, the stretching machine used is not limited to a particular type, but rather may be selected from a variety of stretching machines as long as it allows for continuous oblique stretching of a long film.

In addition, the temperature at which the thermoplastic resin is subjected to oblique stretching is preferably in the range of Tg−30° C. to Tg+60° C., and more preferably in the range of Tg−10° C. to Tg+50° C., where Tg is the glass-transition temperature of the thermoplastic resin. In addition, the stretching ratio is normally from 1.01 times to 30 times, preferably from 1.01 times to 10 times, and more preferably from 1.01 times to 5 times.

Examples of the thermoplastic resins which can be used to form the optical film 70 include, but are not particularly limited to, cycloolefin polymers, polycarbonate, polyarylate, polyethylene terephthalate, triacetyl cellulose, polysulfone, polyethersulfone, polyphenylene sulfide, polyimide, polyamide imide, polyvinyl chloride, polystyrene, polyolefin (such as polyethylene and polypropylene), polyvinyl alcohol, and polyvinyl chloride-polymethyl methacrylate. Among these, preferred are cycloolefin polymers, polycarbonate, polyethylene terephthalate, and triacetyl cellulose, particularly preferred are cycloolefin polymers because of their low relative permittivity, and particularly preferred are cycloolefin polymers without a polar group such as an amino group, a carboxyl group, and a hydroxyl group because of their low relative permittivity and low water absorption.

Examples of cycloolefin polymers may include norbornene-based resins, monocyclic olefin-based resins, cyclic conjugated diene-based resins, vinyl alicyclic hydrocarbon-based resins, and hydrides thereof. Among these, norbornene-based resins are suitably used because of their good transparency and good formability.

Examples of norbornene-based resins may include: a ring-opened polymer of a monomer with norbornene structure, a ring-opened copolymer of a monomer with norbornene structure and another monomer, and hydrides thereof; and an addition polymer of a monomer with norbornene structure, an addition copolymer of a monomer with norbornene structure and another monomer, and hydrides thereof.

Examples of commercially available cycloolefin polymers include “Topas” (manufactured by Ticona GmbtH), “ARTON” (manufactured by JSR Corporation), “ZEONOR” and “ZEONEX” (manufactured by Zeon Corporation), “APEL” (manufactured by Mitsui Chemicals, Inc.), all of which are trade names. By forming such a cycloolefin-based resin into a film, the optical film 70 made from a thermoplastic resin can be obtained. For film formation, a known film formation method is appropriately used, such as a solvent casting method and a melt extrusion method. Cycloolefin-based resin films obtained by a film formation method are also commercially available, and examples thereof include “Essina” and “SCA40” (manufactured by Sekisui Chemical Co., Ltd.), “ZEONOR Film” (manufactured by Zeon Corporation), and “ARTON FILM” (manufactured by JSR Corporation), all of which are trade names. A thermoplastic resin film before stretching is generally a long unstretched film. In this context, a “long” film indicates a film having a length of at least about 5 times or more, preferably 10 times or more, the width of the film, and specifically a film having a length long enough for the film to be wound into a roll for storage or transportation.

The aforementioned thermoplastic resin has a glass-transition temperature of preferably 80° C. or higher, and more preferably from 100° C. to 250° C. In addition, the photoelastic coefficient of the thermoplastic resin is, in absolute value, preferably 10×10⁻¹² Pa⁻¹ or less, more preferably 7×10⁻¹² Pa⁻¹ or less, and particularly preferably 4×10⁻¹² Pa⁻¹ or less. By using a transparent resin whose photoelastic coefficient falls within this range, it is possible to reduce variations in in-plane direction retardation Re of the optical film. Moreover, when such an optical film is applied to a display device using a liquid crystal panel, it is possible to suppress a phenomenon that alters the hue at edges of the display screen of the display device.

It is noted that the thermoplastic resin used in the formation of the optical film 70 may be blended with another compounding agent, and examples thereof include those exemplified earlier in relation to the thermoplastic resin used in the formation of the substrate 40, and the compounding amount of the compounding agent is preferably within the range disclosed in relation to the thermoplastic resin used in the formation of the substrate 40.

Additionally, the thickness of the stretched film used as the optical film 70 is, for example, suitably set in the range of approximately 5 μm to 200 μm, and is preferably from 20 μm to 100 μm. If the thickness of the film is excessively small, strength or retardation value can be insufficient, while the thickness is excessively large, transparency can be deteriorated and it can be difficult to obtain a desired retardation value.

In addition, for the stretched film used as the optical film 70, it is preferred that the content of volatile components remaining in the film is 100 ppm by mass or less. A stretched film whose volatile component content is in the above range is free from display unevenness even after prolonged use, and presents great stability of optical properties. Here, the volatile components are substances that are contained in trace amounts in the thermoplastic resin, that have a molecular weight of 200 or less, and that have a relatively low boiling point, and examples thereof include residual monomers remained in the thermoplastic resin after polymerization of the thermoplastic resin, and the solvent. The content of volatile components may be determined by analyzing the thermoplastic resin with gas chromatography.

Examples of methods of obtaining a stretched film having a volatile component content of 100 ppm by mass or less include: (a) performing oblique stretching of an unstretched film having a volatile component content of 100 ppm by mass or less; and (b) performing oblique stretching of an unstretched film having a volatile component content of more than 100 ppm by mass, and drying the film during or after the oblique stretching to reduce the volatile component content. Among these, the method (a) is preferred for obtaining a stretched film with a lower volatile component content. In the method (a), to obtain an unstretched film having a volatile component content of 100 ppm by mass or less, it is preferred to perform melt extrusion of a resin having a volatile component content of 100 ppm by mass or less.

Additionally, the stretched film used as the optical film 70 preferably has a saturated water absorption of 0.01 mass % or less, and more preferably 0.007 mass % or less. If the saturated water absorption exceeds 0.01 mass %, the stretched film may be subject to dimensional changes depending on the usage environment, and internal stress may occur. Additionally, for example, when using a reflection type liquid crystal panel as the liquid crystal panel 20, display unevenness can occur, such as partial lightening of a black presentation (assuming a whitish appearance). By contrast, a stretched film whose saturated water absorption is in the above range is free from display unevenness even after prolonged use, and presents great stability of optical properties.

It is noted that the saturated water absorption of the stretched film may be adjusted by changing, for example, the type of the thermoplastic resin used in the formation of the film.

Also, the relative permittivity of the stretched film used as the optical film 70 is not particularly limited, yet is preferably 2 or more and preferably 5 or less, and particularly preferably 2.5 or less.

Moreover, a hard coat layer and/or a low refractive index layer may be formed on one or both surfaces of the optical film 70. The hard coat layer and the low refractive index layer of the optical film 70 may use the same material as the hard coat layer and the low refractive index layer mentioned earlier in relation to the substrate 40, and may be formed with the same method.

Further, the display device with a capacitive touch panel according to the disclosure may not have the optical film 70.

[Cover Layer]

The cover layer 80 may be formed by using a known member, for example, a plate that is made of glass or plastic and is transparent to visible light.

Additionally, in the display device with a capacitive touch panel 100, since the second conductive layer 30 is provided on the substrate 40, there is no need to separately provide a transparent base plate for forming the second conductive layer. Moreover, since the first conductive layer 50 is provided on the liquid crystal panel-side protective film 61 of the viewing-side polarizing plate 60, there is also no need to provide a transparent base plate for forming the first conductive layer. Accordingly, it is possible to simplify the structure of the touch sensor and reduce the number of members present between the liquid crystal panel 20 and the cover layer 80, thereby reducing the thickness between the liquid crystal panel 20 and the cover layer 80. As a result, it is possible to reduce the thickness of the display device. It is noted that since a conductive layer is formed on only one surface of the substrate 40 in the display device 100, a conductive layer having a uniform thickness can be formed easily as compared to the case where conductive layers are formed on both surfaces of the substrate 40.

Additionally, with the display device with a capacitive touch panel 100, since the optical film 70 with a predetermined phase difference is arranged between the viewing-side polarizing plate 60 and the cover layer 80, it is possible to convert linearly polarized light traveling through the viewing-side polarizing plate 60 towards the cover layer 80 side into circularly polarized light or elliptically polarized light. Thus, the display device with a capacitive touch panel 100 enables the operator to visually recognize the displayed content on the display device through polarized sunglasses even under the condition of so-called crossed nicols, in which the transmission axis of the polarized sunglasses worn by the operator and the transmission axis of the polarizing film 62 of the viewing-side polarizing plate 60 are set orthogonal to each other

Moreover, in the display device 100 of the aforementioned example, since the substrate 40 is disposed between the first conductive layer 50 and the second conductive layer 30, a capacitive touch sensor can be easily formed. Further, since a film exhibiting low relative permittivity and low saturated water absorption can be used as the substrate 40, a capacitive touch sensor can be formed favorably.

### Display Device with Capacitive Touch Panel

### Second Embodiment

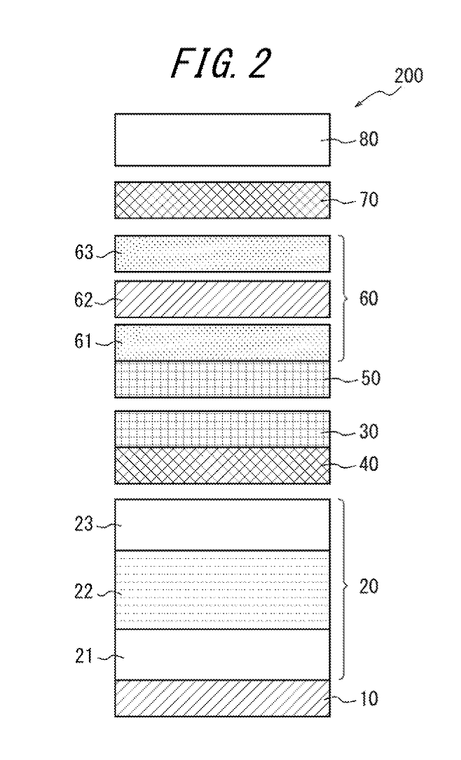

A variation of the aforementioned display device with a capacitive touch panel 100 will now be described below, and the structure of the main part thereof is illustrated in FIG. 2.

The display device with a capacitive touch panel 200 illustrated in FIG. 2 differs from the example of the display device with a capacitive touch panel 100 as described previously in the following points:
the second conductive layer 30 is formed on a surface of the substrate 40 on the cover layer 80 side; and
the first conductive layer 50 and the second conductive layer 30 are bonded together via an adhesive layer or pressure sensitive adhesive layer having low relative permittivity (not shown).

The display device with a capacitive touch panel 200 has otherwise the same features as the display device with a capacitive touch panel 100.

Here, the bonding of the substrate 40 on the liquid crystal panel 20 may be performed by using a known adhesive layer or pressure sensitive adhesive layer.

Here, as the adhesive layer or pressure sensitive adhesive layer used to bond the first conductive layer 50 and the second conductive layer 30 together, it is possible to use an adhesive layer or pressure sensitive adhesive layer which is formed from, for example, a resin having low relative permittivity, such as acrylic-based, urethane-based, epoxy-based, vinylalkylether-based, silicone-based, and fluorine-based resins. It is noted that from the viewpoint of forming a capacitive touch sensor favorably, the adhesive layer or pressure sensitive adhesive layer preferably has a relative permittivity of 2 or more and 5 or less.

Additionally, in the aforementioned display device with a capacitive touch panel 200, as is the case with the example of the display device with a capacitive touch panel 100 as described previously, it is possible to simplify the structure of the touch sensor and reduce the number of members present between the liquid crystal panel 20 and the cover layer 80, thereby reducing the thickness between the liquid crystal panel 20 and the cover layer 80.

Also, as is the case with the aforementioned example of the display device with a capacitive touch panel 100, the display device 200 enables the operator to visually recognize the displayed content even under the condition of so-called crossed nicols, in which the transmission axis of the polarizing sunglasses worn by the operator and the transmission axis of the polarizing film 62 of the viewing-side polarizing plate 60 are set orthogonal to each other.

### Display Device with Capacitive Touch Panel

### Third Embodiment

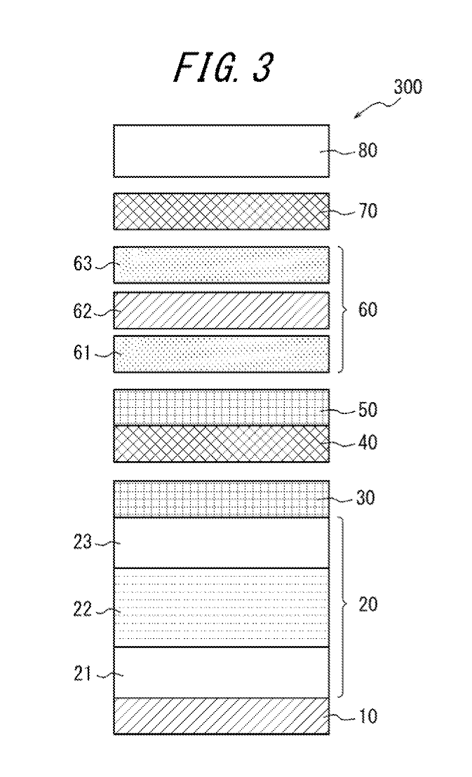

FIG. 3 illustrates the structure of the main part of another example of the display device with a capacitive touch panel according to the disclosure.

Here, the display device with a capacitive touch panel 300 illustrated in FIG. 3 differs from the example of the display device with a capacitive touch panel 100 as described previously in the following points:
the second conductive layer 30 is formed not on the surface of the substrate 40, but on one surface of the liquid crystal panel 20 on the cover layer 80 side (specifically on one surface of the color filter base plate (cover layer-side cell base plate) 23 on the cover layer 80 side); and
the first conductive layer 50 is formed not on the surface of the viewing-side polarizing plate 60 on the liquid crystal panel 20 side (specifically on the surface of the liquid crystal panel-side protective film 61 on the liquid crystal panel 20 side), but on the surface of the substrate 40 on the cover layer 80 side.

The display device with a capacitive touch panel 300 has otherwise the same features as the display device with a capacitive touch panel 100.

Here, the formation of the second conductive layer 30 on the color filter base plate 23 and the formation of the first conductive layer 50 on the substrate 40 may be performed by using the same method as used in the formation of the conductive layers in the display device with a capacitive touch panel 100.

Additionally, in the aforementioned display device with a capacitive touch panel 300, as is the case with the example of the display device with a touch panel 100 as described previously, it is possible to simplify the structure of the touch sensor and reduce the number of members present between the liquid crystal panel 20 and the cover layer 80, thereby reducing the thickness between the liquid crystal panel 20 and the cover layer 80.

Also, as is the case with the aforementioned example of the display device with a capacitive touch panel 100, the display device 300 enables the operator to visually recognize the displayed content even under the condition of so-called crossed nicols, in which the transmission axis of the polarizing sunglasses worn by the operator and the transmission axis of the polarizing film 62 of the viewing-side polarizing plate 60 are set orthogonal to each other.

Moreover, in the display device 300, a capacitive touch sensor may be formed easily and favorably by using the substrate 40.

### Display Device with Capacitive Touch Panel

### Forth Embodiment

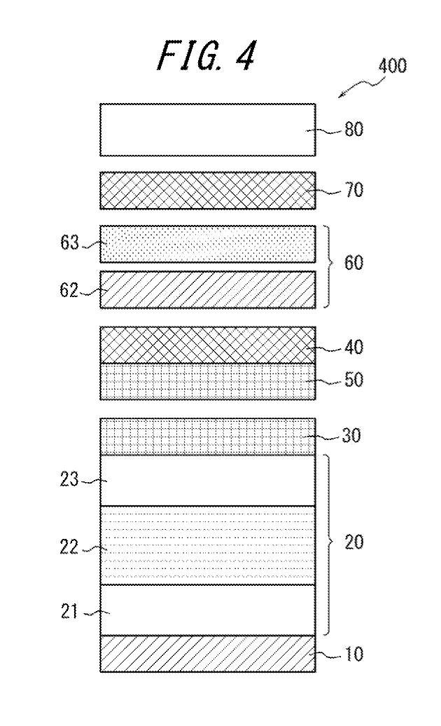

A variation of the aforementioned display device with a capacitive touch panel 300 will now be described below, and the structure of the main part thereof is illustrated in FIG. 4.

The display device with a capacitive touch panel 400 illustrated in FIG. 4 differs from the example of the display device with a capacitive touch panel 300 as described previously in the following points:
the viewing-side polarizing plate 60 does not have the liquid crystal panel-side protective film 61, and the polarizing film 62 is positioned on a surface of the viewing-side polarizing plate 60 on the liquid crystal panel 20 side (the lower surface in FIG. 4);
the first conductive layer 50 is formed on a surface of the substrate 40 on the liquid crystal panel 20 side;
the substrate 40 is bonded to a surface, on the liquid crystal panel 20 side, of the polarizing film 62 of the viewing-side polarizing plate 60; and
the first conductive layer 50 and the second conductive layer 30 are bonded together via an adhesive layer or pressure sensitive adhesive layer having low relative permittivity (not shown).

The display device with a capacitive touch panel 400 have otherwise the same features as the display device with a capacitive touch panel 300.

Here, the bonding of the substrate 40 on the polarizing film 62 may be performed by using a known adhesive layer or pressure sensitive adhesive layer.

In addition, as the adhesive layer or pressure sensitive adhesive layer used to bond the first conductive layer 50 and the second conductive layer 30 together, it is possible to use the same adhesive layer or pressure sensitive adhesive layer as that used in the display device with a capacitive touch panel 200 which is formed from, for example, a resin having low relative permittivity, such as acrylic-based, urethane-based, epoxy-based, vinylalkylether-based, silicone-based, and fluorine-based resins. It is noted that from the viewpoint of forming a capacitive touch sensor favorably, the adhesive layer or pressure sensitive adhesive layer preferably has a relative permittivity of 2 or more and 5 or less.

Additionally, in the aforementioned display device with a capacitive touch panel 400, as is the case with the example of the display device with a touch panel 300 as described previously, it is possible to simplify the structure of the touch sensor and reduce the number of members present between the liquid crystal panel 20 and the cover layer 80, thereby reducing the thickness between the liquid crystal panel 20 and the cover layer 80.

Also, the display device 400 enables the operator to visually recognize the displayed content even under the condition of so-called crossed nicols, in which the transmission axis of the polarizing sunglasses worn by the operator and the transmission axis of the polarizing film 62 of the viewing-side polarizing plate 60 are set orthogonal to each other.

It is noted that in the display device 400, it is possible to cause the substrate 40 to function as a protective film for the polarizing film 62, which may thus make the liquid crystal panel-side protective film of the viewing-side polarizing plate 60 unnecessary, thereby reducing the thickness of the viewing-side polarizing plate 60. Accordingly, it is possible to further reduce the thickness between the liquid crystal panel 20 and the cover layer 80.

While examples of the display device with a capacitive touch panel according to the disclosure have been described above, the display device with a capacitive touch panel according to the disclosure is not limited to the above examples, but is capable of modifications as deemed appropriate. Specifically, if the display device with a capacitive touch panel according to the disclosure has any additional member other than the substrate between the viewing-side polarizing plate and the display panel, one of the first conductive layer and the second conductive layer that is not formed on the surface of the substrate may be formed on a surface of the additional member.

### INDUSTRIAL APPLICABILITY

According to the disclosure, it is possible to provide a display device with a capacitive touch panel that is reduced in thickness.

In addition, according to a preferred embodiment of the disclosure, it is possible to provide a display device with a capacitive touch panel that can be operated even through polarized sunglasses and is reduced in thickness.

### REFERENCE SIGNS LIST

10 Backlight-side polarizing plate
20 Liquid crystal panel
21 Thin film transistor base plate
22 Liquid crystal layer
23 Color filter base plate
30 Second conductive layer
40 Substrate
50 First conductive layer
60 Viewing-side polarizing plate
61 Liquid crystal panel-side protective film
62 Polarizing film
63 Cover layer-side protective film
70 Optical film
80 Cover layer
100, 200, 300, 400 Display device with capacitive touch panel

1. A display device with a capacitive touch panel comprising a laminate between a display panel and a cover layer, the laminate having a viewing-side polarizing plate, a first conductive layer, a second conductive layer, and a substrate, wherein
the viewing-side polarizing plate has a polarizing film, and
the first conductive layer, the second conductive layer, and the substrate are positioned closer to the display panel than is the polarizing film of the viewing-side polarizing plate, and the first conductive layer is positioned closer to the cover layer than is the second conductive layer,
the first conductive layer and the second conductive layer are arranged apart from each other in a stacking direction so as to form a capacitive touch sensor, and
one of the first conductive layer and the second conductive layer is formed on one surface of the substrate.

2. The display device with a capacitive touch panel according to claim 1, further comprising an optical film with a phase difference of (2n−1)λ/4, where n is a positive integer, between the cover layer and the viewing-side polarizing plate, wherein
a slow axis of the optical film intersects a transmission axis of the polarizing film of the viewing-side polarizing plate at an angle of about 45° as viewed in the stacking direction.

3. The display device with a capacitive touch panel according to claim 1, wherein
the viewing-side polarizing plate has a display panel-side protective film on the side of the display panel of the polarizing film,
the first conductive layer is formed on a surface, on the side of the display panel, of the display panel-side protective film of the viewing-side polarizing plate, and
the second conductive layer is formed on one surface of the substrate.

4. The display device with a capacitive touch panel according to claim 3, wherein the second conductive layer is formed on a surface of the substrate on the side of the display panel.

5. The display device with a capacitive touch panel according to claim 3, wherein the second conductive layer is formed on a surface of the substrate on the side of the cover layer.

6. The display device with a capacitive touch panel according to claim 1, wherein
the display panel has a cover layer-side cell base plate at a surface thereof on the side of the cover layer,
the second conductive layer is formed on a surface, on the side of the cover layer, of the cover layer-side cell base plate of the display panel, and
the first conductive layer is formed on one surface of the substrate.

7. The display device with a capacitive touch panel according to claim 6, wherein the first conductive layer is formed on a surface of the substrate on the side of the cover layer.

8. The display device with a capacitive touch panel according to claim 6, wherein the first conductive layer is formed on a surface of the substrate on the side of the display panel.

9. The display device with a capacitive touch panel according to claim 8, wherein
the polarizing film is positioned on a surface of the viewing-side polarizing plate on the side of the display panel, and
the substrate is bonded to a surface of the polarizing film on the side of the display panel.

10. The display device with a capacitive touch panel according to claim 2, wherein the optical film is an obliquely stretched film.

11. The display device with a capacitive touch panel according to claim 1, wherein a cycloolefin polymer, polycarbonate, polyethylene terephthalate, or triacetyl cellulose is used in at least one of the substrate and the optical film.

12. The display device with a capacitive touch panel according to claim 11, wherein a cycloolefin polymer without a polar group is used in at least one of the substrate and the optical film.

13. The display device with a capacitive touch panel according to claim 1, wherein the substrate has a relative permittivity of 2 or more and 5 or less.

14. The display device with a capacitive touch panel according to claim 4, wherein the substrate has a relative permittivity of 2 or more and 5 or less.

15. The display device with a capacitive touch panel according to claim 1, wherein the substrate has a saturated water absorption of 0.01 mass % or less.

16. The display device with a capacitive touch panel according to claim 14, wherein the substrate has a saturated water absorption of 0.01 mass % or less.

17. The display device with a capacitive touch panel according to claim 16, wherein a cycloolefin polymer without a polar group is used in at least one of the substrate and the optical film.

18. The display device with a capacitive touch panel according to claim 1, wherein the substrate has a film, and further has at least one of a first index matching layer positioned between the film and the first conductive layer, and a second index matching layer positioned between the film and the second conductive layer.

19. The display device with a capacitive touch panel according to claim 1, wherein at least one of the first conductive layer and the second conductive layer is formed by using indium tin oxide, carbon nanotubes, or silver nanowires.

20. The display device with a capacitive touch panel according to claim 1, wherein the display panel is a liquid crystal panel formed with a liquid crystal layer sandwiched between two cell base plates.

21. The display device with a capacitive touch panel according to claim 7, wherein the substrate has a relative permittivity of 2 or more and 5 or less.

22. The display device with a capacitive touch panel according to claim 21, wherein the substrate has a saturated water absorption of 0.01 mass % or less.

23. The display device with a capacitive touch panel according to claim 22, wherein a cycloolefin polymer without a polar group is used in at least one of the substrate and the optical film.
